(19) United States
(12) Patent Application Publication
(10) Pub. No.: US 2023/0365745 A1
(43) Pub. Date: Nov. 16, 2023

(54) HEAT SHRINKABLE FILMS, AND METHOD OF MANUFACTURING THE SAME

(71) Applicant: Klöckner Pentaplast of America, Inc., Gordonsville, VA (US)

(72) Inventors: Hongliang ZHANG, Songjiang District, Shanghai (CN); Manuel SCHURR, Heiligenroth (DE); Christian DUX, Tüßling (DE)

(21) Appl. No.: 18/028,390

(22) PCT Filed: Sep. 29, 2021
(86) PCT No.: PCT/US2021/052620

§ 371 Date: Mar. 24, 2023

(30) Foreign Application Priority Data
Sep. 30, 2020 (CN) 202011056708.0

(51) Int. Cl. C08G 63/199; C08G 63/183; B29C 71/02; C08J 5/18; C08L 67/02; B29C 61/02; B32B 27/08; B32B 27/36

(52) U.S. Cl. CPC C08G 63/199; C08G 63/183; C08J 7/08; C08J 5/18; C08L 67/02; B29C 61/02; B32B 27/08; B32B 27/36; C08J 2367/02; C08J 2467/02; B29K 2067/003

(57) ABSTRACT

The present invention relates to a heat shrinkable film having a shrink onset temperature of 60° C. or lower and a shrink tension of 6 N/mm² or lower. The film comprises a copolyester and/or copolyester blend derived from components including a terephthalic acid or an ester thereof; ethylene glycol (EG); 2-methyl-1,3-propanediol (MPO); diethylene glycol (DEG); and one or both of 2-dimethylpropane-1,3-diol (NPG) and 1,4-cyclohexanedimethanol (CHDM).

### CROSS-REFERENCE TO RELATED APPLICATIONS

This application claims priority to Chinese Patent Application No. 202011056708.0, entitled “HEAT SHRINKABLE FILMS, AND METHOD OF MANUFACTURING THE SAME” filed on Sep. 30, 2020. The contents of the aforementioned patent application are incorporated herein by reference in their entirety.

### FIELD

The present invention relates to heat shrinkable films. More particularly, the present invention relates to heat shrinkable films for shrink-to-fit labelling of packaging, such as food and drink packaging.

### BACKGROUND

Heat-shrinkage films are known and commercially available for example to cover and protect articles, to hold articles together, to label articles and to provide tamper-evident protection.

Polyvinyl chloride (PVC) and polystyrene (PS), especially orientated polystyrene (OPS), are commonly used to produce heat shrinkable films. Typically, the polymeric material is prepared, extruded into a film, biaxially and/or monoaxially stretched and rolled into rolls. At the packer's facility, the film is unfolded, printed, seamed to form a tube and applied around an article. The film is then heated to a shrink temperature so that it shrinks back to fit tightly around the article. In some applications, the container contains food or drink before labelling; in other applications, the shrink label is applied on an empty container. The heat shrinkable film may have a relatively high shrink tension, as the content will prevent the container from deforming under the pressure of the shrinking film. However, it is often not desirable or possible to expose a filled container, even partially, to heat, as this may spoil the food/drink products, especially where the shrink film has a high shrink onset temperature. However, without content, heat shrinkable films having a high shrink tension will tend to deform or crush the empty containers. With low shrink onset temperatures and low shrink tensions (5 and 3 N/mm², respectively), PVC and OPS have been the preferred materials for the production of shrink films. However, these materials are not commonly recyclable, and where they are, the recycling process requires the separation of the PVS or OPS films from containers made from a different material before each material type can be recycled. Therefore, PVC and OPS shrink films are incompatible with the noticeable shift in and beyond the industry towards environmentally-friendly solutions.

Polyethylene terephthalate (PET) is commonly used in the food and drink packaging industry. In particular, amorphous polyethylene terephthalate (APET) is favoured for its versatility, clarity and recyclability, and is frequently used to manufacture food and drink containers (including for example food trays and containers, bowls, cups and bottles). Therefore, a “monopolymer packaging” comprising a PET bottle with a PET shrink film is advantageous. However, in order to be suitable for shrink film applications, the ability of APET to crystallise must be reduced. Glycol-modified polyethylene terephthalate (commonly referred to as “PET-G” and “PETG”) has a suitably low crystallinity; however, with a shrink tension of between 7 to 12 N/mm², it is unsuitable for the effective wrapping/labelling of empty containers. Furthermore, the shrink onset temperature remains high.

Other modifications have been considered to improve the shrink properties of shrink films. For example, US patent publications U.S. Pat. Nos. 5,589,126, 8,765,240 and 7,008,698 are examples of publications describing additives used in shrink films. However, none of the resulting films exhibits the required combination of properties. Whether the modification is mechanical (e.g. coextrusion, blending), chemical (e.g. film composition, additives) or process-based (e.g. stretch or shrink conditions), known shrink copolyester films achieve a suitably low shrink tension combined with low shrink onset temperature.

### SUMMARY

It is thus an object of the present invention to mitigate problems such as those described above and to provide an improved alternative to existing products. In particular, it is an object of the present invention to provide an environmentally-friendly heat shrinkable film with shrink properties suitable for use on empty or less rigid containers.

According to a first aspect of the present invention, there is provided a heat shrinkable film comprising a copolyester derived from components including a terephthalic acid (TA or PTA) or an ester thereof component; and a diol component comprising ethylene glycol (EG), 2-methyl-1,3-propanediol (MPO), diethylene glycol (DEG), and one or both of 2-dimethylpropane-1,3-diol (NPG or Neopentylglycol) and 1,4-cyclohexanedimethanol (CHDM). Preferably, the film has a shrink onset temperature of 60° C. or lower and a shrink tension of 6 N/mm² or lower.

According to a second aspect of the present invention, there is provided a heat shrinkable film comprising a copolyester blend comprising a first polymer and a second polymer, wherein the first polymer is derived from components including a terephthalic acid or an ester thereof component and a first diol component comprising ethylene glycol (EG), 2-methyl-1,3-propanediol (MPO) and diethylene glycol (DEG); and the second polymer is derived from components including a terephthalic acid or an ester thereof component, and a second diol component comprising ethylene glycol (EG), and one or both of 2-dimethylpropane-1,3-diol (NPG or Neopentylglycol) and 1,4-cyclohexanedimethanol (CHDM). Preferably, the film has a shrink onset temperature of 60° C. or lower and a shrink tension of 6 N/mm² or lower

The heat shrinkable film according to the present invention, comprising a copolyester alone or a blend of copolyesters, has a sufficiently low shrink tension, and a low shrink onset temperature.

Importantly, the inventors have observed that MPO- and/or DEG-modified films, in particular PET films, have aging issues, in that their shrink properties deteriorate significantly over time. For example, it has been observed that, when stored at or under room temperature for extended periods of time, the elongation in the MD direction decreases, and the shrinkage in the TD direction decreases.

The inventors have discovered that the combination of the specific monomers used in the present invention results in a heat shrinkable film which is environmentally-friendly, which has a low shrink tension and a low shrink onset temperature, and the film properties, in particular shrink and elongation properties, of which has an improved aging performance. In particular, it has been observed that the use of NPG and/or CHDM improves the stability the shrink and elongation properties of the copolyester over long periods of time.

The same improved properties are achieved with a co-extruded multilayer film comprising the same components. Consequently, according to a third aspect of the present invention, there is provided a multilayer heat shrinkable film made from monomers including a terephthalic acid (TA or PTA) or an ester thereof component; and a diol component comprising ethylene glycol (EG), 2-methyl-1,3-propanediol (MPO), diethylene glycol (DEG), and one or both of 2-dimethylpropane-1,3-diol (NPG or Neopentylglycol) and 1,4-cyclohexanedimethanol (CHDM). Preferably, the multilayer heat shrinkable film comprises at least one layer comprising or consisting of NPG and/or CHDM. Preferably, the multilayer heat shrinkable film comprises at least one layer comprising or consisting of MPO and/or DEG.

In a preferred embodiment, the multilayer heat shrinkable film comprises at least one layer comprising (a) a copolyester derived from components including a terephthalic acid (TA or PTA) or an ester thereof component; and a diol component comprising ethylene glycol (EG), 2-methyl-1,3-propanediol (MPO), diethylene glycol (DEG), and one or both of 2-dimethylpropane-1,3-diol (NPG or Neopentylglycol) and 1,4-cyclohexanedimethanol (CHDM); and/or (b) a copolyester blend comprising a first polymer and a second polymer, wherein the first polymer is derived from components including a terephthalic acid or an ester thereof component and a first diol component comprising ethylene glycol (EG), 2-methyl-1,3-propanediol (MPO) and diethylene glycol (DEG); and the second polymer is derived from components including a terephthalic acid or an ester thereof component, and a second diol component comprising ethylene glycol (EG), and one or both of 2-dimethylpropane-1,3-diol (NPG or Neopentylglycol) and 1,4-cyclohexanedimethanol (CHDM).

According to a fourth aspect of the present invention, there is provided a method of manufacturing a heat shrinkable film having a shrink onset temperature of 60° C. or lower and a shrink tension of 6 N/mm² or lower. The method comprises the steps of preparing the copolyester or copolyester blend as described above. The copolyester is prepared by polymerising a terephthalic acid or an ester thereof, ethylene glycol (EG), 2-methyl-1,3-propanediol (MPO), diethylene glycol (DEG), and one or both of 2-dimethylpropane-1,3-diol (NPG) and 1,4-cyclohexanedimethanol (CHDM). The copolyester blend can be prepared by blending a first polymer polymerised from a terephthalic acid or an ester thereof, ethylene glycol (EG), 2-methyl-1,3-propanediol (MPO) and diethylene glycol (DEG), with a second polymer polymerised from a terephthalic acid or an ester thereof, ethylene glycol (EG), and one or both of 2-dimethylpropane-1,3-diol (NPG) and 1,4-cyclohexanedimethanol (CHDM). The method further comprises the step of extruding the copolyester or copolyester blend to obtain a film.

According to a fifth aspect of the present invention, there is provided a method of applying a heat shrinkable film as described above. The method comprises the steps of applying the film onto and/or around an article, and heating the film up to at least its shrink onset temperature.

The multilayer heat shrinkable film according to the third aspect may be produced and/or processed using the methods according to the fourth and fifth aspects.

The present invention relates to a heat shrinkable film having a shrink onset temperature of 60° C. or lower and a shrink tension of 6 N/mm² or lower, said film comprising a copolyester or a copolyester blend, derived from a terephthalic acid or an ester thereof, ethylene glycol (EG), 2-methyl-1,3-propanediol (MPO), diethylene glycol (DEG), and one or both of 2-dimethylpropane-1,3-diol (NPG) and 1,4-cyclohexanedimethanol (CHDM).

The shrink tension is the amount of force the film exerts on an article it is applied to, during the shrinking step. Whilst high shrink tension films may be suitable for robust articles, a lower shrink tension is required for articles which are prone to deformation and/or are unsupported by a content. Furthermore, printed low shrink tension films have been observed to exhibit improved shrinking performance (for example a lower risk of discoloration or colour concentration, lower risk of deformation of the printed image, and lower defect rate). Consequently, the shrink tension of the heat shrinkable film according to the present invention is preferably 6 N/mm² or lower, and most preferably 4.5 N/mm² or lower. Preferably, the shrink temperature is 60 to 75° C. Most preferably, the shrink tension of the heat shrinkable film is 6 N/mm² or lower, or 4.5 N/mm² or lower at a temperature of 60 to 75° C.

The shrink tension can be measured by methods known in the art for example using methods and equipment known in the art (for example test methods ASTM D2838 or DIN 53369:1076-02).

The shrink onset temperature is the temperature at which the film begins to shrink. A lower onset temperature is favoured to minimise the effect of heating upon the article upon which the film is applied. In the case of a plastic article, such as a PET bottle (usually made of APET), the shrink onset temperature of the film is preferably substantially lower than the glass transition temperature of the material of the article, to prevent or minimise any deformation of the article. In addition, the onset temperature of the shrink film is preferably sufficiently low so as not to affect or spoil the content of the container it is applied to. Consequently, the shrink onset temperature of the heat shrinkable film of the present invention is preferably 60° C. or lower. The shrink onset temperature can be measured by methods known in the art for example using test method ASTM-D-2732.

The intrinsic viscosity (IV) is a characteristic of the polymer from which the shrink film is made. The IV of the polymer is dependent upon the weight average molecular weight. The longer the chains, stiffer the material and higher the IV. The IV is linked to the shrink tension and it has been observed that the lower the IV, the lower the shrink tension. However, too low an IV was also observed to bring in low mechanical properties of the film. Consequently, the intrinsic viscosity of the copolyester or copolyester blend used in the present invention is preferably 0.6 dl/g to 0.8 dl/g, more preferably 0.65 to 0.75 dl/g. The intrinsic viscosity can be measured by methods known in the art, for example using test method ASTM D4603-03.

The glass transition temperature (Tg) is the temperature at which an amorphous polymer transitions from a glass-like state to a rubbery state. The Tg value of a polymer can affect many physical properties of a polymer, and in particular, it has been observed that a decrease in the glass transition temperature results in a decrease in the shrink onset temperature. However, too low a Tg will result in the film being sticky or tacky and unsuitable for packaging purposes. Consequently, the glass transition temperature of the polyester or copolyester blend is preferably from 63° C. to 75° C. The glass transition temperature may be determined using methods known in the art for example using thermomechanical analysis (TMA), dynamic mechanical analysis (DMA), and differential scanning calorimetry (DSC).

The crystallisation half-life time is the time required to obtain 50% of the maximum achievable crystallinity in the sample at the prescribed temperature of from 180 to 210° C. after the initial crystallization phase. The crystallisation half-life time is determined with the aid of a differential scanning calorimeter or DSC. Differential scanning calorimetry (DSC) is a standard method for the measurement of thermal properties, in particular of phase transition temperatures of solids. The copolyesters according to the present invention preferably have a crystallisation half-life time of at least 5 minutes in the molten state. In the context of the present invention, the crystallisation half-life was measured using the method described in European patent publication EP 1 066 339.

The stretching temperature is the temperature at which the film is stretched, e.g. after extrusion of the film, before being applied onto an article or support and being shrunk. The stretching temperature of the copolyester or copolyester blend is preferably from 5° C. to 25° C. higher than Tg. The stretching temperature may be determined using methods known in the art.

### BRIEF DESCRIPTION OF THE DRAWING

The invention will be further described with reference to the accompanying FIGURE, in which:

FIG. 1 is the curve of shrink tension as a function of temperature for Example 1.

### DETAILED DESCRIPTION

According to a first embodiment of the present invention, the heat shrinkable film comprises a copolyester polymerised from a terephthalic acid or an ester thereof component; and a diol component comprising ethylene glycol (EG), 2-methyl-1,3-propanediol (MPO), diethylene glycol (DEG), and one or both of 2-dimethylpropane-1,3-diol (NPG) and 1,4-cyclohexanedimethanol (CHDM).

The main resin backbone of the copolyester is formed from the terephthalic acid or an ester thereof, and ethylene glycol.

Terephthalic acid (TA or PTA) is a dicarboxylic acid used in the synthesis of PET and PET-based polymers. The terephthalic acid or ester thereof is preferably terephthalic acid or a dialkyl terephthalate (such as dimethyl terephthalate), more preferably terephthalic acid.

2-methyl-1,3-propanediol (MPO) has been observed to decrease the shrink tension of the copolyester. MPO is present in the diol component preferably in an amount of 5 mol % to 30 mol %, more preferably in an amount of 10 mol % to 25 mol %, and most preferably in an amount of 15 mol % to 20 mol %, based upon 100 mol % of the diol component. Within the context of the present invention, “100 mol % of the diol component” refers to the total amount of diol component.

Diethylene glycol (DEG) has been observed to have little effect on the shrink tension. However, its presence decreased the glass transition temperature of the copolyester, which in turn, reduced the shrink onset temperature. DEG is present in the diol component preferably in an amount of 1 mol % to 15 mol %, more preferably in an amount of 5 mol % to 13 mol %, and most preferably in an amount of 8 mol % to 12 mol %, based upon 100 mol % of the diol component.

The copolyester of the present invention comprising NPG and/or CHDM has been found to have a low shrink tension and a low shrink onset temperature, but also to have improved stability over time. In particular, it has been found that the deterioration of the transverse direction (TD) shrinkage over time and of the elongation at break in the machine direction (MD) are substantially reduced. The TD shrinkage and the MD elongation at break can be measured using methods known in the art, for example using test method ASTM-D-2732 for the TD shrinkage, and ASTM-D-882 (preferably at v=50 mm/min) for the MD elongation at break.

According to the present invention, the diol component comprises NPG and/or CHDM. When both CHDM and NPG are present, the combination of CHDM and NPG is preferably present in the diol component in an amount of 1 mol % to 30 mol %, more preferably in an amount of 3 mol % to 20 mol %, and most preferably in an amount of 5 mol % to 10 mol %, based upon 100 mol % of the diol component. In a preferred embodiment, the diol component comprises NPG and does not comprise CHDM.

2-dimethylpropane-1,3-diol (NPG) is present in the diol component preferably in an amount of 1 mol % to 30 mol %, more preferably in an amount of 3 mol % to 20 mol %, more preferably in an amount of 5 mol % to 15 mol %, and most preferably in an amount of 7 mol % to 12 mol %, based upon 100 mol % of the diol component, when the diol component does not comprise CHDM.

1,4-cyclohexanedimethanol (CHDM) is present in the diol component preferably in an amount of 1 mol % to 30 mol %, more preferably in an amount of 2 mol % to 20 mol %, more preferably in an amount of 3 mol % to 15 mol %, and most preferably in an amount of 5 mol % to 10 mol %, based upon 100 mol % of the diol component, when the diol component does not comprise NPG.

When taking into account the amounts of MPO, DEG and NPG/CHDM, the remainder of the diol component may be ethylene glycol (EG). Alternatively, ethylene glycol (EG) is present in the diol component preferably in an amount of 45 mol % to 90 mol %, more preferably in an amount of 55 mol % to 80 mol %, and most preferably in an amount of 60 mol % to 70 mol %, based upon 100 mol % of the diol component.

The mole ratio of MPO to the total amount of NPG and/or CHDM in the diol component is preferably from 1:5 to 5:1. Such a mole ratio results in the film having shrink properties which are less prone to degradation over time, whilst having a low shrink tension.

The mole ratio of MPO to DEG in the diol component is preferably from 5:1 to 1:1. Such a mole ratio results in the film having a particularly beneficial balance of a low shrink tension and a low onset temperature.

In a preferred embodiment, the diol component preferably comprises MPO in an amount of 5 to 30 mol %; DEG in an amount of 1 to 15 mol %; NPG in an amount of 1 to 30 mol %; and a remainder of EG, based upon 100 mol % of the diol component, wherein preferably the diol component does not comprise CHDM. Such a diol component results in the film having a particularly beneficial balance of properties, such as a low shrink tension, a low onset temperature and a high resistance to deterioration of the transverse direction (TD) shrinkage over time. This balance of properties makes the film ideal for wrapping/labelling empty containers.

According to a second embodiment of the present invention, the heat shrinkable film comprises a copolyester blend comprising a first polymer and a second polymer.

The first polymer is polymerised from a terephthalic acid or an ester thereof component; and a first diol component comprising ethylene glycol (EG), 2-methyl-1,3-propanediol (MPO) and diethylene glycol (DEG). The second polymer is polymerised from a terephthalic acid or an ester thereof component; and a second diol component comprising ethylene glycol (EG) and one or both of 2-dimethylpropane-1,3-diol (NPG) and 1,4-cyclohexanedimethanol (CHDM).

The mass ratio of the first polymer to the second polymer in the blend is preferably from 1:9 to 9:1, more preferably 1:1 to 1:3. Such a mass ratio results in the film having a particularly advantageous balance of a low shrink tension, a low onset temperature and a good resistance to deterioration of the shrink and elongation properties over time.

2-methyl-1,3-propanediol (MPO) is preferably present in the first diol component in an amount of 5 mol % to 40 mol %, and most preferably in an amount of 20 mol % to 35 mol %, based upon 100 mol % of the first diol component.

Diethylene glycol (DEG) is preferably present in the first diol component in an amount of 1 mol % to 20 mol %, and most preferably in an amount of 5 mol % to 15 mol %, based upon 100 mol % of the first diol component.

When taking into account the amounts of MPO and DEG, the remainder of the first diol component may be ethylene glycol (EG). Alternatively, ethylene glycol (EG) is preferably present in the first diol component in an amount of 45 mol % to 90 mol %, and most preferably in an amount of 50 mol % to 70 mol %, based upon 100 mol % of the first diol component.

The mole ratio of MPO to DEG in the first diol component is preferably from 5:1 to 1:1.

In a preferred embodiment, the first diol component comprises MPO in an amount of 5 to 40 mol %; DEG in an amount of 1 to 20 mol %; and a remainder of EG, based upon 100 mol % of the first diol component.

According to the present invention, the second diol component comprises NPG and/or CHDM. When both CHDM and NPG are present, the combination of CHDM and NPG is preferably present in the second diol component in an amount of 1 mol % to 40 mol %, and most preferably in an amount of 10 mol % to 30 mol %, based upon 100 mol % of the second diol component. In a preferred embodiment, the second diol component comprises NPG and does not comprise CHDM. Alternatively, the second diol component may comprise CHDM and not comprise NPG.

2-dimethylpropane-1,3-diol (NPG) is preferably present in the second diol component in an amount of 1 mol % to 40 mol %, and most preferably in an amount of 20 mol % to 35 mol %, based upon 100 mol % of the second diol component, when the second diol component does not comprise CHDM.

1,4-cyclohexanedimethanol (CHDM) is preferably present in the second diol component in an amount of 1 mol % to 40 mol %, and most preferably in an amount of 10 mol % to 25 mol %, based upon 100 mol % of the second diol component, when the second diol component does not comprise NPG.

When taking into account the amount of NPG/CHDM, the remainder of the second diol component may be ethylene glycol (EG). Alternatively, ethylene glycol (EG) is preferably present in the second diol component in an amount of 45 mol % to 90 mol %, and most preferably in an amount of 60 mol % to 80 mol %, based upon 100 mol % of the second diol component.

In a preferred embodiment, the second diol component comprises NPG in an amount of 1 to 40 mol % and a remainder of EG, based upon 100 mol % of the second diol component, and preferably the second diol component does not comprise CHDM.

The film may consist of the copolyester, or of the copolyester blend, or may further include other additives, such as one or more colouring agents, antiblock agents, stabilizing agents, lubricants, anti-oxidation agents, anti-hydrolysis agents, impact modifiers, and the like.

According to the present invention, the heat shrinkable film may be a multilayer film comprising at least one layer comprising the copolyester and/or the copolyester blend as described hereinabove. The multilayer film is preferably co-extruded, and may comprise one or more additional layers, such as a layer comprising one or more colouring agents, antiblock agents, stabilizing agents, lubricants, anti-oxidation agents, anti-hydrolysis agents, impact modifiers, and the like.

The present invention also relates a method of manufacturing the heat shrinkable film, the method comprising the steps of preparing the copolyester or copolyester blend according the invention, and extruding the copolyester or copolyester blend to obtain a film.

Any method conventional in the art may be used to prepare the copolyester from the terephthalic acid or ester thereof component and the diol component. For instance, the copolyester may be prepared by random copolymerisation of the terephthalic acid or ester thereof component and the diol component.

Similarly, any method conventional in the art may be used to prepare the first and second polymers of the copolyester blend. For instance, the first polymer may be prepared by random copolymerisation of the terephthalic acid or ester thereof component and the first diol component, and the second polymer may be prepared by random copolymerisation of the terephthalic acid or ester thereof component and the second diol component. The first polymer and second polymer are blended together using any method known in the art. For example, cold blend pellets of the first polymer and cold blend pellets of the second polymer are added to a mixer equipped with an agitator paddle, and the pellets are then mixed for 40-80 seconds.

The copolyester or copolyester blend is then formed into a film by a conventional method of extrusion, in step (b). For example, the copolyester or copolyester blend is added to a twin-screw extruder, and extruded to a thickness of about 180 to 350 μm at a temperature 230-280° C.

The method may further comprise the step (c) of stretching the film obtained from step (b). The film may be stretch orientated in one or more directions to impart strength, toughness and other desirable properties to the film. The film is preferably stretched 2 to 7 times its original dimensions. For example, the film is stretched 4-6 times in a tender frame to produce a copolyester film having a thickness of about 40-90 μm. The stretching temperature is typically 5-25° C. higher than Tg of the copolyester or copolyester blend.

The stretching of the film results in a proportional reduction of the thickness of the heat shrinkable film. Preferably, the film has a thickness between 30 to 90 μm after it has been stretched.

The present invention provides a method of applying the heat shrinkable film according to the invention onto a support. The method comprises the steps of applying the film onto and/or around the support; and heating to a temperature which is higher than the shrink onset temperature of the film.

The present invention is particularly advantageous when used in shrink-to-fit applications. In the application step, it is typical to seam the heat shrinkable film along the machine direction (MD), for example with a solvent, to form a tube. The tube is then applied around the article, e.g. a container such as a bottle or cup.

The present invention is particularly advantageous when used with articles which are prone to deformation under shrink tension. However, the film according to the present invention may be applied to more robust articles.

In the heating step, the temperature is elevated at least until it reaches the shrink onset temperature of the film. Preferably, the film is heated at a temperature of about 60 to 100° C. The heating step may be performed in a heat shrink tunnel. The heat causes the heat shrinkable film to shrink and fit tightly around the support, without distorting the film (and in particular any printing applied thereon) and without deforming the container.

The films according to the present invention are also particularly advantageous in that they achieve high shrinkage at low temperature ranges (60° C. to 70° C.). Generally, the shrink temperature needs to be relatively low, in particular when labelling empty containers made of high-density polyethylene (HDPE), polypropylene (PP) or polystyrene (PS), so as to avoid container deformation. However, the lower the shrink temperature, the lower the TD shrinkage, so that too low a temperature would result in insufficient shrink around the container, with the risk of the labels not being secured to the container. The films of the present invention exhibit the minimum shrinkage required, which meets the strict labelling requirements (40-60% preferably, 70-80% most preferably), combined with a low onset temperature.

Optionally, the heat shrinkable film may be printed on before the film is applied onto the article or support.

The discussion of non-essential features, whether using the term “preferable”, “embodiment” or otherwise, should not be understood to represent a specific teaching or example which cannot be combined with other non-essential features described in similar terms. Such features may be combined together, within the limits of technical compatibility as recognised by the skilled person.

### EXAMPLES

The Examples provided herein are for illustrative purposes only, and do not limit the scope of the invention, which is defined in the claims Unless otherwise stated, “%’ as used in the Examples refers to “mol %”.

Examples 1 to 5 relate to films, and resins for the preparation of films, according to the present invention. Comparative Examples A to B relate to known films and resins.

### EXAMPLE 1

### EXAMPLE 1.1—Preparation of a Copolymerised Polyester Resin

An exemplary method of preparing a copolymerised polyester resin (Example 1) used in the present invention is described.

### Step 1: Esterification

In a stainless-steel reactor equipped with a stirrer, a thermometer and a refluxing condenser, 8600 g PTA (100 mol %), 2390 g EG (62*1.2 mol %), 1007 g MPO (18*1.2 mol %), 659 g DEG (10*1.2 mol %), 647g NPG (10*1.2 mol %), 3.5 g Sb₂(EG)₃ and 3 g NaAc were mixed together, and heated to about 250° C. under a nitrogen atmosphere. EG, MPO, DEG and NPG are preferably added in excess (1.2 times in excess in this example). The pressure in the reactor was kept between 0.4 MPa to 0.6 MPa, until the esterification ratio was up to 97%.

### Step 2: Polycondensation

The pressure in the reactor was then adjusted to normal pressure, the temperature was increased to about 280° C., and the pressure was step-wise reduced to about 100 Pa. The excess alcohol was pumped out of the reactor using a vacuum pump. Polycondensation was conducted at 280° C. under the reduced pressure of about 100 Pa for about 3 hours, to form the copolyester of Example 1.

The copolymerised polyester resins of Example 2 and Comparative Examples A and B were prepared using the same exemplary method as that used for Example 1. The proportions of each component are listed below in Table 1.

TABLE 1

| | | | Comparative | Comparative |
|---|---|---|---|---|
| | Ex. 1 | Ex. 2 | Ex. A | Ex. B |
| TA | 100% | 100% | 100% | 100% |
| EG | 62% | 66% | 72% | 72% |
| MPO | 18% | 17% | None | 28% |
| DEG | 10% | 10% | None | None |
| NPG | 10% | None | 28% | None |
| CHDM | none | 7% | None | None |

### EXAMPLE 1.2—Preparation of a Polyester Blend

An exemplary method of preparing the copolyester blend (Example 3) used in the present invention is described.

The blend comprises a first polymer and a second polymer. The composition of the first polymer is prepared from 100 mol % PTA, 62 mol % EG, 28 mol % MPO and 10 mol % DEG. A commercially available polymer is used as the second polymer, for example Huahong Wushi™ 501 (an NPG-based PET-G) or Eastman Embrace™ LV (a CHDM-based PET-G).

3000 g of pellets of the first polymer and 7000 g of pellets of the second polymer were cold blended in a mixer equipped with agitator paddle. The pellets were mixed for 40 to 80 seconds before adding the mixture to a twin-screw extruder for film making.

The copolyester blends of Examples 4 and 5 were prepared using the same exemplary method as that used for Example 3. The proportions of each component are listed below in Table 2.

TABLE 2

| | | | | Comparative |
|---|---|---|---|---|
| | Ex. 3 | Ex. 4 | Ex. 5 | Ex. C |
| First | 30% | 30% | 40% | 100% |
| polymer | | | | |
| (by mass) | | | | |
| TA | 100% | 100% | 100% | 100% |
| EG | 62% | 62% | 62% | 62% |
| MPO | 28% | 28% | 28% | 28% |
| DEG | 10% | 10% | 10% | 10% |
| Second | 70% | 70% | 60% | 0% |
| polymer | Huahong | Eastman | Huahong | |
| (by mass) | Wushi ™ | Embrace ™ | Wushi ™ | |
| | 501 | LV | 501 | |

### EXAMPLE 2—Preparation of a Heat Shrinkable Film

The copolymerised polyester resin or copolyester blend is fed to a twin-screw extruder, and extruded at a temperature 230° C-280° C., to obtain an unstretched film with a thickness of about 180 to 350 μm.

The stretching temperature was measured and studied on a lab scale film stretcher which is equipped with a thermal couple in the stretching chamber. The extruded film is then stretched 4-6 times in a tender frame at a stretching temperature is 5-25° C. higher than the glass transition temperature (Tg) of the copolyester material, to produce a copolyester film having a thickness of about 40-90 μm, for example stretched 5 times in the TD direction. The stretched film may be rolled into rolls, or prepared as sheets of film (for example of A4 size).

The exemplary parameters are listed in Table 3 below.

TABLE 3

| | Extrusion | Unstretched | Stretching | Stretched |
|---|---|---|---|---|
| | Temperature | thickness | temperature | thickness |
| | (° C.) | (μm) | (° C.) | (μm) |
| Ex. 1 | 220 | 200 | 85 | 40 |
| Ex. 2 | 220 | 200 | 85 | 40 |
| Ex. 3 | 250 | 200 | 85 | 40 |
| Ex. 4 | 250 | 200 | 85 | 40 |
| Ex. 5 | 250 | 200 | 85 | 40 |
| Comp. Ex. A | 250 | 200 | 85 | 40 |
| Comp. Ex. B | 220 | 200 | 85 | 40 |
| Comp. Ex. C | 220 | 200 | 85 | 40 |

### EXAMPLE 3—Evaluation of Film Properties

The intrinsic viscosity (IV) was measured according ASTM D4603-03. The inherent viscosity of the polyesters was determined in 60/40 (wt/wt) phenol/tetrachloroethane at a concentration of 0.5 g/100 ml at 25° C.

Between 0.2475 and 0.2525 g of sample was accurately weighed into a clean dry 50 mL volumetric flask. About 25 mL 60/40 (wt/wt) phenol/tetrachloroethane was added into the flask, which was then heated for about 15 minutes to dissolve the sample. Once the sample was completely dissolved, the flask was left to cool down and additional solvent was added to 50 mL. The solution was poured into a Cannon-Ubbelohde viscometer, and the IV was tested in a constant temperature bath at 25° C.

The glass transition temperature (Tg) of the copolyesters was measured using Differential Scanning calorimetry (DSC)instrument TA Q-20, with a sample of 7 mg, a temperature sweep of from 30 to 280° C., and a speed of 10° C/min. The glass transition temperature (Tg) of the polyesters was determined using a TA Q-20 instrument from Thermal Analyst Instruments at a scan rate of 10° C./min according to ASTM D3418.

The glass transition temperatures and intrinsic viscosity values of the blend samples were not measured, since these parameters are truly accurate only with respect to single polymer-types. In theory, a blend sample comprising two distinct polymer-types would exhibit two Tg peaks; and the IV characteristic would be affected by thermal variations in the blending process.

TABLE 4

| | Glass transition | Intrinsic |
|---|---|---|
| | temperature | viscosity |
| | (° C.) | (dl/g) |
| Ex. 1 | 65 | 0.70 |
| Ex. 2 | 65 | 0.70 |
| Ex. 3 (blend) | — | — |
| Ex. 4 (blend) | — | — |
| Ex. 5 (blend) | — | — |
| Comp. Ex. A | 71 | 0.72 |
| Comp. Ex. B | 69 | 0.66 |
| Comp. Ex. C | 62 | 0.67 |

### EXAMPLE 4—Evaluation of Shrink Properties

This example demonstrates that the heat shrink film according to the present invention has excellent shrink properties, comparable to those of OPS and PVC shrink films.

PVC was commercially available as Pentalabel® from Kleckner Pentaplast and OPS was commercially available as OPS SSH000 from Dongil Chemical.

The shrink tension was measured in accordance to DIN 53369:1076-02 “Testing of plastic films; determination of the shrinking stress”).

The testing conditions used were as follows:
Heating rate: 102° C./h
Sample dimensions : 10 mm×10 mm×40 μm
Pretension: 0-0.2 N/mm²
Number of samples: 3 (to obtain a statistical medium value)

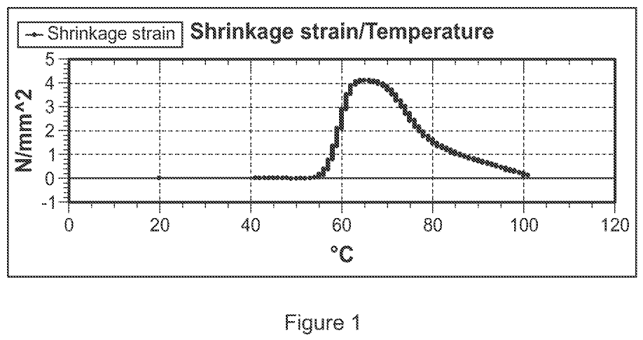

The 40 μm film was cut into strips of 100 mm by 10 mm, and 40 μm thickness, and clamped to a measurement holder with force sensors. The sample together with the holder was moved to a heating chamber and the temperature was gradually increased from 40° C. to 100° C. with a heating speed of 102° C./h. A curve of tension as a function of temperature was plotted using the data measured by the sensors. By way of illustration, the shrink tension determination curve for Example 1 is provided in FIG. 1. The shrink tension was determined as the maximum tension of the curve.

The onset temperature was measured using test method ASTM-D-2732. The films are cut to 100 mm by 100 mm samples with the aid of a template (40 μm thickness), and placed into a shrink holder. The bath temperature is set to the desired temperature within +/−0.5° C. and stabilized. The samples are immersed with the shrink holder to the water for 30 seconds. The shrink onset temperature is the temperature at which a 2% shrinkage is achieved.

TABLE 5

| | Shrink | Shrink onset | Shrinkage | Shrinkage | Shrinkage |
|---|---|---|---|---|---|
| | tension | temperature | (TD) (%) | (TD) (%) | (TD) (%) |
| | (N/mm²) | (° C.) | at 55° C./30 s | at 60° C./30 s | at 95° C./30 s |
| Ex. 1 | 4.1 | 53 | 7% | 40% | 75% |
| Ex. 2 | 4.7 | 53 | 5% | 38% | 75% |
| Ex. 3 | 6.0 | 57 | 1% | 7% | 77% |
| Ex. 4 | 5.8 | 57 | 1% | 8% | 77% |
| Ex. 5 | 5.9 | 56 | 1% | 20% | 77% |
| Comp. Ex. A | 9.7 | 60 | 0% | 1% | 78% |
| Comp. Ex. B | 2.6 | 54 | 3% | 25% | 72% |
| Comp. Ex. C | 2.4 | 53 | 7% | 37% | 72% |
| * T43 (NPG) | 10 | 61 | 0 | 1% | 77% |
| ** T52 (CHDM) | 7 | 60 | 0 | 1% | 77% |
| *** T147/07 (PVC) | 3.8 | 64 | 0 | 0 | 58% |
| **** OPS | 4.5 | 55 | 1% | 3% | 70% |

* Pentalabel ® Rigid PETg TDO G10F33-T43 (45 μm)
** Pentalabel ® Rigid PETg TDO G10F22-T52 (45 μm)
*** Pentalabel ® Rigid Vinyl TDO 147/07-T25 (45 μm)
**** Dongil Chemical SSH000 OPS (45 μm)

The films according to the present invention exhibit a shrink tension (6 N/mm² or below), which is sufficiently low so as to be used for labelling empty containers, and containers with a relatively low inherent structural rigidity. The shrink tension is comparable to that of PVC. In addition, the shrink onset temperature is consistently lower than that of PVC, and comparable to that of OPS.

It can also be observed that Comparative Example A, which does not comprise MPO or DEG, has a significantly higher shrink tension. The shrink tension of 9.7 N/mm² of Comparative Example A would not be suitable for the present purposes. Additionally, the shrink onset temperature is comparable to that of PVC.

Comparative Example B, which comprises no DEG, has a suitable low shrink force and shrink onset temperature.

Comparative Example C, which comprises both MPO and DEG, has suitably low shrink tension and shrink onset temperature. However, as will be demonstrated below, the properties of this film degrade over time.

### EXAMPLE 5—Evaluation of the Stability of Shrink Properties

The machine direction (MD) elongation, MD elongation after 4 months ageing, transverse direction (TD) shrinkage at 60° C./30 s and TD shrinkage at 60° C./30 s after 8 months ageing were measured.

The machine direction (MD) elongation at break was measured monthly using test method ASTM-D-882 at v=50 mm/min. The transverse direction (TD) was measured monthly using test method ASTM-D-2732.

The results are set out in Table 6 below.

TABLE 6

| | | MD | | |
|---|---|---|---|---|
| | | elongation | | TD @60° C./30 S |
| | MD | after 4 | TD @60° C./ | after 8 months |
| | elongation | months | 30 S | aging |
| Ex. 1 | >200% | >200% | 40% | 38% |
| Ex. 2 | >200% | >200% | 38% | 32% |
| Ex. 3 | >200% | >200% | 7% | 7% |
| Ex. 4 | >200% | >200% | 8% | 8% |
| Ex. 5 | >200% | >200% | 20% | 19% |
| Comp. Ex. A | >200% | >200 | 1% | 1% |
| Comp. Ex. B | >200% | <5% | 25% | 0% |
| Comp. Ex. C | >200% | <5% | 37% | 27% |

The films of Examples 1 to 5 according to the present invention comprise NPG and/or CHDM, and it is observed that both their shrink properties are stable over time. This allows for these films to be safely stored over a period of time, before they are finally use.

Comparative Example A also comprises NPG and exhibits the same aging stability. However, as demonstrated in Table 5, the shrink properties of this film are not suitable for the present purposes.

Comparative Examples B and C do not comprise NPG or CHDM, and it is observed that the shrink properties deteriorate significantly over a period of a few months. Consequently, these films may exhibit favourable shrink properties when they are made, but cannot be used effectively as shrink films if stored before use.

### EXAMPLE 6—Application of the Film Onto an Article

The film roll or sheet is optionally printed using a suitable ink material, with the required information and patterns. The printed film is seamed, using a solvent, to form a film tube of suitable dimensions. The film tube is positioned around a container (for example a bottle). The container and the tube are transferred into a heat shrink tunnel, heated at a temperature greater than the film shrink temperature. The film shrinks to achieve tight labelling around the container, without causing distortion of the printing or deformation of the container.

As demonstrated hereinabove, the combination of the specific monomers used in the present invention, results in a heat shrinkable film which is environmentally-friendly, which has a low shrink tension and a low shrink onset temperature, and the physical properties, in particular shrink and elongation properties, of which do not deteriorate over time.

Although the present invention has been described within the context of food and drink packaging applications, it is envisaged that it could have other advantageous implementations in fields in which shrink films are used.

1. A heat shrinkable film having a shrink onset temperature of 60° C. or lower and a shrink tension of 6 N/mm² or lower, said film comprising a copolyester derived from components including:
(i) a terephthalic acid or an ester thereof; and
(ii) a diol component comprising:
ethylene glycol (EG);
2-methyl-1,3-propanediol (MPO);
diethylene glycol (DEG); and
one or both of 2-dimethylpropane-1,3-diol (NPG) and 1,4-cyclohexanedimethanol (CHDM).

2. A heat shrinkable film according to claim 1, wherein the diol component comprises NPG and not CHDM.

3. A heat shrinkable film according to claim 2, wherein NPG is present in the diol component in an amount of 1 mol % to 30 mol %, based upon 100 mol % of the diol component.

4. A heat shrinkable film according to claim 1, wherein the diol component comprises CHDM and not NPG.

5. A heat shrinkable film according to claim 4, wherein CHDM is present in the diol component in an amount of 1 mol % to 30 mol %, based upon 100 mol % of the diol component.

6. A heat shrinkable film according to claim 1, wherein MPO is present in the diol component in an amount of 5 mol % to 30 mol %, based upon 100 mol % of the diol component.

7. A heat shrinkable film according to claim 1, wherein DEG is present in the diol component in an amount of 1 mol % to 15 mol %, based upon 100 mol % of the diol component.

8. A heat shrinkable film according to claim 1, wherein EG is present in the diol component in an amount of 45 mol % to 90 mol %, based upon 100 mol % of the diol component.

9. A heat shrinkable film according to claim 1, wherein the mole ratio of MPO to the total amount of NPG and CHDM in the diol component is from 1:5 to 5:1.

10. A heat shrinkable film according to claim 1, wherein the mole ratio of DEG to the total amount of NPG and CHDM in the diol component is from 1:30 to 2:1.

11. A heat shrinkable film according to claim 1, wherein the mole ratio of MPO to DEG in the diol component is from 5:1 to 1:1.

12. A heat shrinkable film according to claim 1, wherein the mole ratio of NPG to CHDM when both are present in the diol component is from 1:30 to 30:1.

13. A heat shrinkable film according to claim 1, wherein the diol component comprises:
MPO in an amount of 5 to 30 mol %;
DEG in an amount of 1 to 15 mol %;
NPG in an amount of 1 to 30 mol %; and
a remainder of EG,
based upon 100 mol % of the diol component.

14. A heat shrinkable film having a shrink onset temperature of 60° C. or lower and a shrink tension of 6 N/mm² or lower, said film comprising a copolyester blend comprising a first polymer and a second polymer, wherein the first polymer is derived from components including:
(i) a terephthalic acid or an ester thereof; and
(ii) a first diol component comprising ethylene glycol (EG), 2-methyl-1,3-propanediol (MPO) and diethylene glycol (DEG), and
the second polymer is derived from components including:
(iii) a terephthalic acid or an ester thereof component; and
(iv) a second diol component comprising: ethylene glycol (EG) and one or both of 2-dimethylpropane-1,3-diol (NPG) and 1,4-cyclohexanedimethanol (CHDM).

15. A heat shrinkable film according to claim 14, wherein the mass ratio of the first polymer to the second polymer in the blend is from 1:9 to 9:1.

16. A heat shrinkable film according to claim 14, wherein the second diol component comprises NPG and not CHDM.

17. A heat shrinkable film according to claim 16, wherein NPG is present in the second diol component in an amount of 1 mol % to 40 mol %, based upon 100 mol % of the second diol component.

18. A heat shrinkable film according to claim 14, wherein the second diol component comprises CHDM and not NPG.

19. A heat shrinkable film according to claim 18, wherein CHDM is present in the second diol component in an amount of 1 mol % to 40 mol %, based upon 100 mol % of the second diol component.

20. A heat shrinkable film according to claim 14, wherein MPO is present in the first diol component in an amount of 5 mol % to 40 mol %, based upon 100 mol % of the first diol component.

21. A heat shrinkable film according to claim 14, wherein DEG is present in the first diol component in an amount of 1 mol % to 20 mol %, based upon 100 mol % of the first diol component.

22. A heat shrinkable film according to claim 14, wherein EG is present in the first diol component in an amount of 45 mol % to 90 mol %, based upon 100 mol % of the first diol component.

23. A heat shrinkable film according to claim 14, wherein EG is present in the second diol component in an amount of 45 mol % to 90 mol %, based upon 100 mol % of the second diol component.

24. A heat shrinkable film according to claim 14, wherein the mole ratio of MPO to DEG in the first diol component is from 5:1 to 1:1.

25. A heat shrinkable film according to claim 14, wherein the mole ratio of NPG to CHDM when both are present in the second diol component is from 30:1 to 1:30.

26. A heat shrinkable film according to claim 14 wherein the first diol component comprises:
MPO in an amount of 5 to 40 mol %;
DEG in an amount of 1 to 20 mol %; and
a remainder of EG,
based upon 100 mol % of the first diol component.

27. A heat shrinkable film according to claim 14, wherein the second diol component comprises:
NPG in an amount of 1 to 40 mol %; and
a remainder of EG,
based upon 100 mol % of the second diol component.

28. A multilayer heat shrinkable film made from monomers including:
(i) a terephthalic acid or an ester thereof; and
(ii) a diol component comprising:
ethylene glycol (EG);
2-methyl-1,3-propanediol (MPO);
diethylene glycol (DEG); and
one or both of 2-dimethylpropane-1,3-diol (NPG) and 1,4-cyclohexanedimethanol (CHDM).

29. The multilayer heat shrinkable film according to claim 28, wherein the film comprises at least one layer comprising or consisting of NPG and/or CHDM.

30. The multilayer heat shrinkable film according to claim 28, wherein the film comprises at least one layer comprising or consisting of MPO and/or DEG.

31. (canceled)

32. The multilayer heat shrinkable film according to claim 28, wherein the film is co-extruded.

33. (canceled)

34. (canceled)

35. (canceled)

36. (canceled)

37. A method of applying a heat shrinkable film as defined in claim 1 onto a support, the method comprising the steps of:
applying the film onto and/or around the support;
heating up to a temperature greater than the shrink onset temperature of the film.

38. The method according to claim 37, wherein in the heating step, the film is heated at a temperature of 60° C. to 150° C.
